(19) United States
(12) Patent Application Publication
(10) Pub. No.: US 2016/0263798 A1
(43) Pub. Date: Sep. 15, 2016

(54) PROCESS OF MANUFACTURING CAP OF A COSMETIC CONTAINER BY INJECTION MOLDING TWICE

(71) Applicant: LI-MEI LIU, New Taipei City (TW)

(72) Inventor: LI-MEI LIU, New Taipei City (TW)

(21) Appl. No.: 14/642,454

(22) Filed: Mar. 9, 2015

(51) Int. Cl. B29C 45/16; B29C 45/40; B29C 45/72; A45D 40/04

(52) U.S. Cl. CPC B29C 45/1676; A45D 40/04; B29C 45/40; B29C 45/72; B29L 2031/7184

(57) ABSTRACT

A process of manufacturing cap of a cosmetic container is provided with heating and melting polymers, feeding the molten polymers into a first mold, cooling and hardening the molten polymers to form a cap in the first mold, and ejecting the cap from the first mold; feeding the cap into a second mold, and heating a polymeric material to a preset temperature until the polymeric material is molten wherein the preset temperature is sufficient to melt an inner surface of the cap; injecting the molten polymeric material into the cap to coat the inner surface of the cap, cooling and hardening the cap, and ejecting the cap from the second mold; and forming a resilient layer on the inner surface of the cap by the polymeric material, and releasably securing a casing assembly to an open end of the cap.

### BACKGROUND OF THE INVENTION

1. Field of the Invention

The invention relates to process of manufacturing cosmetic containers and more particularly to a process of manufacturing a cap of a cosmetic container by injection molding the cap first and subsequently injecting a polymeric material into an inner surface of the cap to form a resilient layer which can be elastically deformed to obtain a leakproof interior of the cap when the cap and the casing assembly are secured together.

2. Description of Related Art

Conventionally, in manufacturing a cosmetic container, a cap and a casing are formed by injection molding. A leakproof pad is formed on the blind bottom of the cap by applying adhesive. However, the desired leakproof feature is not reliable because the adhesive is not coated uniformly. Further, the cap may be deformed permanently due to its flexible nature. As such, the cap is no longer leakproof after a period of time of use. Furthermore, closing the cosmetic container may be difficult and it may be inconvenient in use.

Thus, the need for improvement still exists.

Notwithstanding the prior art, the invention is neither taught nor rendered obvious thereby.

### SUMMARY OF THE INVENTION

It is therefore one object of the invention to provide a process of manufacturing a cap of a cosmetic container comprising the steps of heating and melting polymers, feeding the molten polymers into a first mold, cooling and hardening the molten polymers to a configuration of the first mold to form a cap, and ejecting the cap from the first mold; feeding the cap into a second mold, and heating a polymeric material to a predetermined temperature until the polymeric material is molten wherein the predetermined temperature is sufficient to melt an inner surface of the cap; injecting the molten polymeric material into the cap to coat the inner surface of the cap, cooling and hardening the cap, and ejecting the cap from the second mold wherein the polymeric material is adhered to the inner surface of the cap; and forming a resilient layer on the inner surface of the cap by the polymeric material, and releasably securing a casing assembly to an open end of the cap.

The above and other objects, features and advantages of the invention will become apparent from the following detailed description taken with the accompanying drawings.

### BRIEF DESCRIPTION OF THE DRAWINGS

FIG. 1 is a flow chart illustrating a process of manufacturing cap of a cosmetic container by injection molding twice according to the invention;

FIG. 2 is a perspective view of the produced cosmetic container;

FIG. 3 is an exploded view of the cosmetic container;

FIG. 3A is a longitudinal sectional view of the cap;

FIG. 4 is a longitudinal sectional view of the cosmetic container;

FIG. 5 is a longitudinal sectional view of the cap but showing in an enlarged scale;

FIG. 6 is a longitudinal sectional view of the cosmetic container showing a joining operation of the cap and the casing assembly; and

FIG. 6A is a detailed view of the area in circle A of FIG. 6.

### DETAILED DESCRIPTION OF THE INVENTION

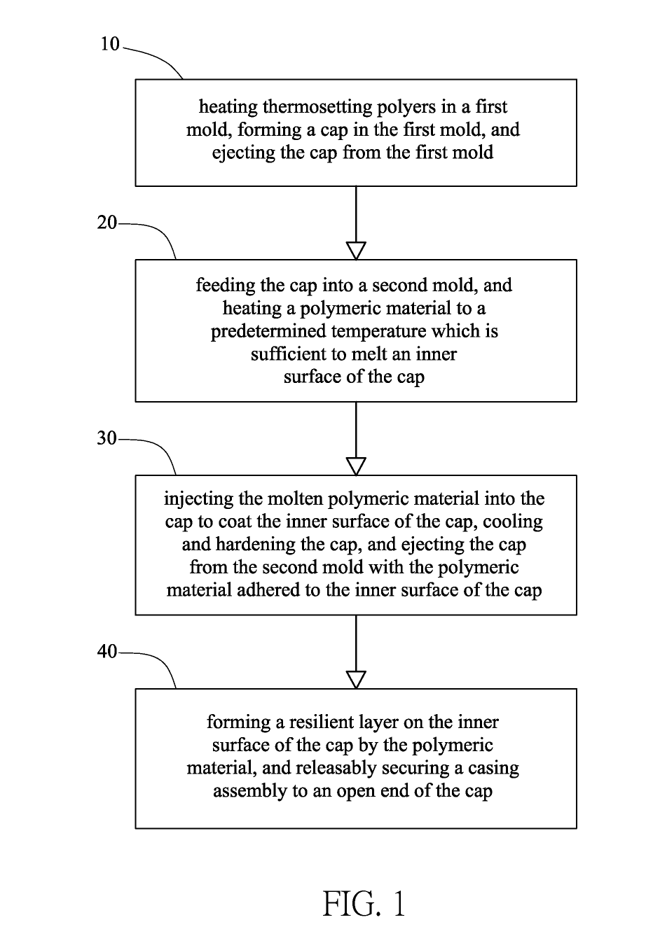

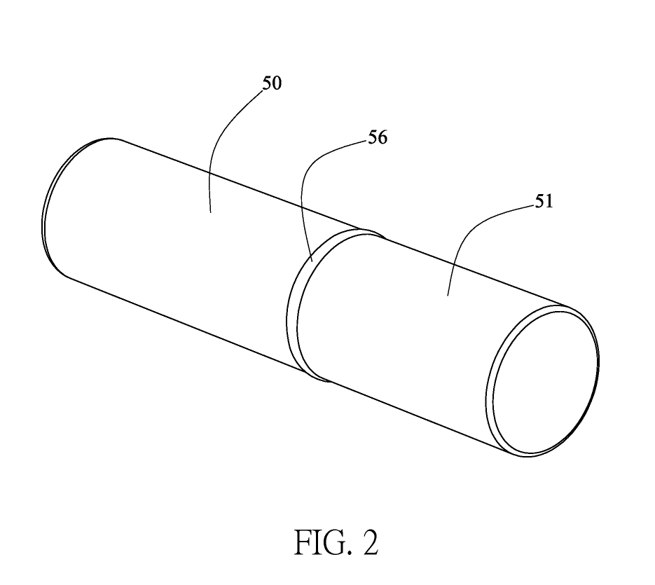

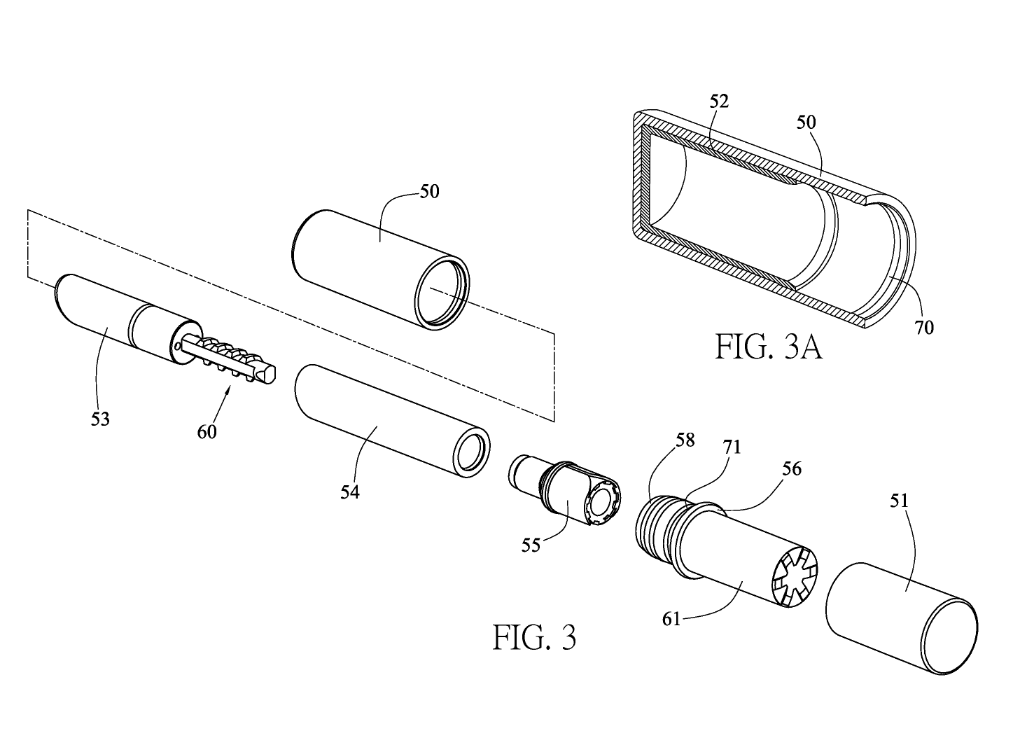

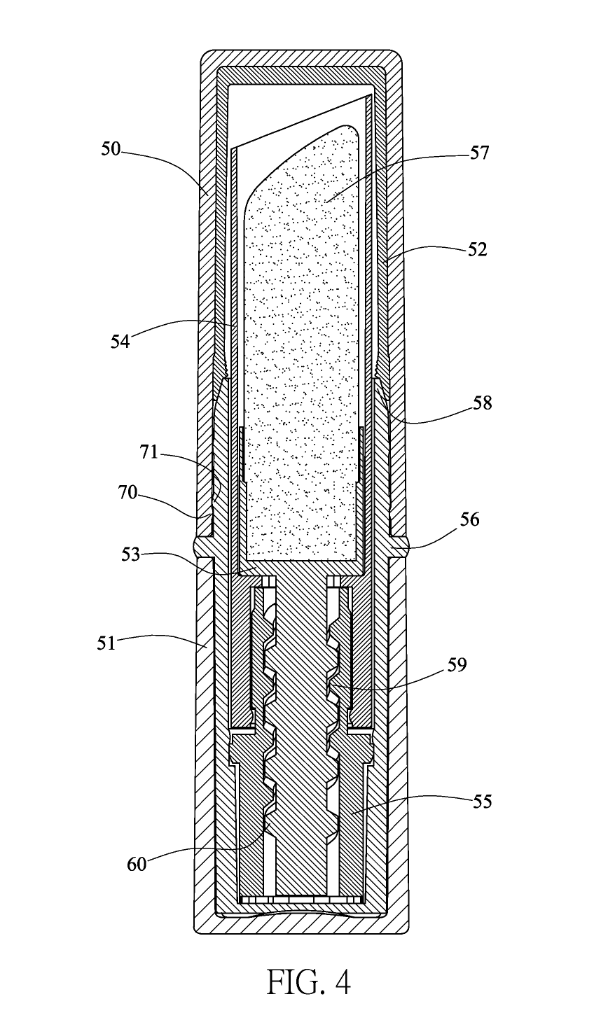

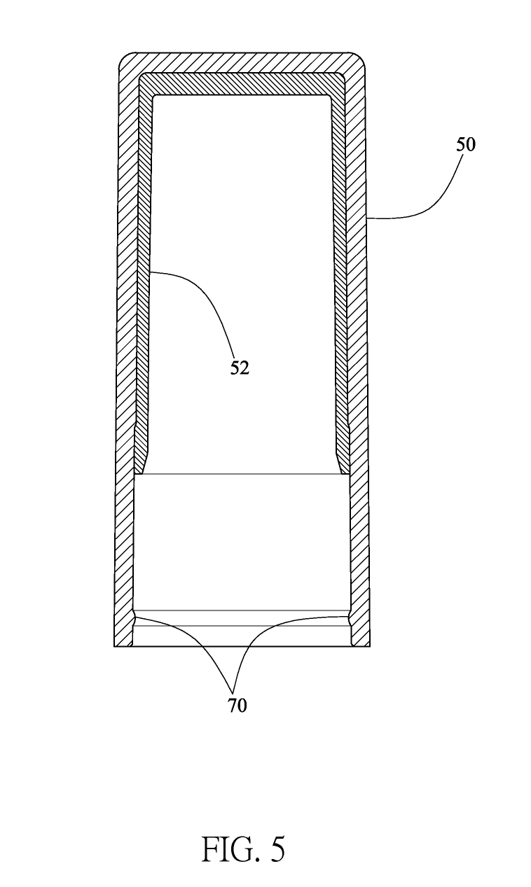

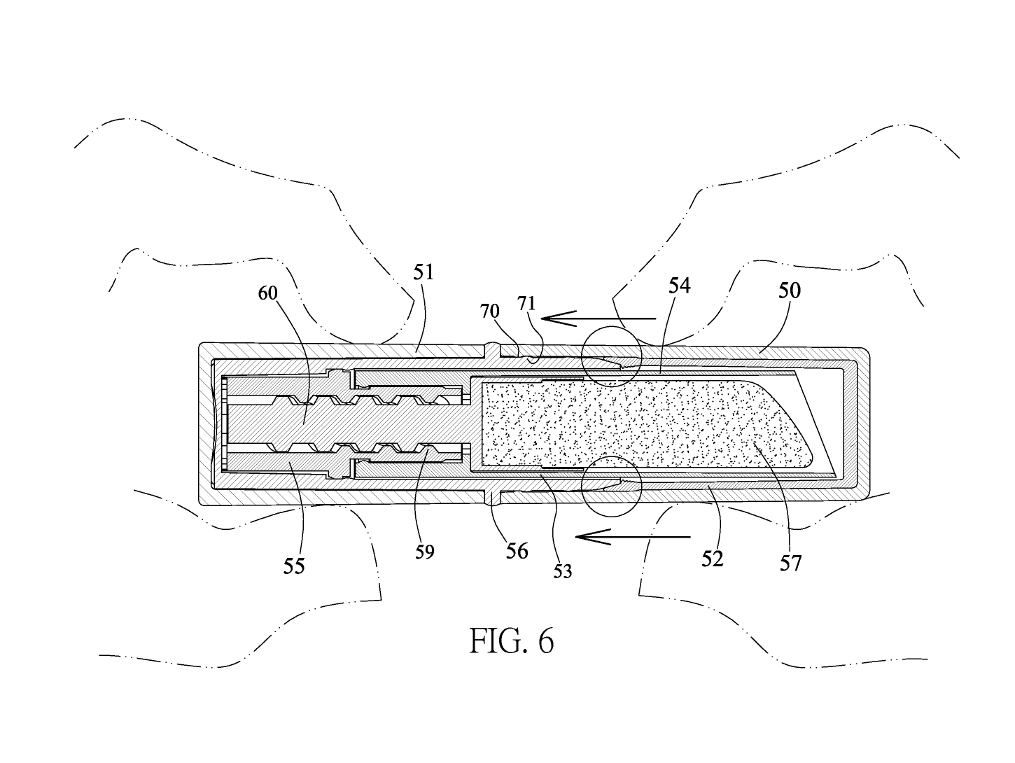

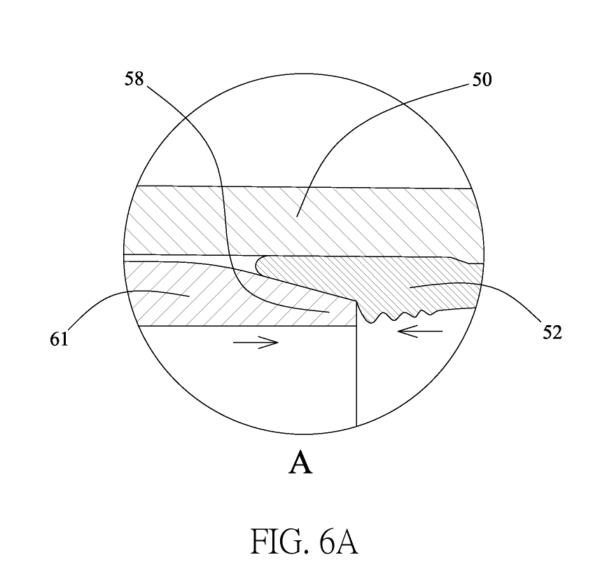

Referring to FIGS. 1 to 6, a process of manufacturing cap of a cosmetic container by injection molding twice in accordance with the invention is illustrated. The process comprises the following steps:

In step 10, polymers (e.g., thermosetting polymers) are heated and fed into a first mold, the heated polymers are cooled and hardened to the configuration of the first mold (e.g., a cap 50), and the cap 50 is ejected from the first mold.

In step 20, the cap 50 is fed into a second mold, and a polymeric material is heated to a predetermined temperature which is sufficient to melt an inner surface of the cap 50.

In step 30, the molten polymeric material is injected into the cap 50 to coat the inner surface of the cap 50, the cap 50 is cooled and hardened, and the cap 50 is ejected from the second mold in which the polymeric material is adhered to the inner surface of the cap 50.

In step 40, a resilient layer 52 is formed on the inner surface of the cap 50 by the polymeric material, and a casing assembly 51 is prepared and is releasably secured to an open end of the cap 50.

The casing assembly 51 includes an interior casing 61, an annular flange 56 at an intermediate portion of the interior casing 61, an annular first ridge 71 forwardly of the flange 56, and a rim 58 forwardly of the first ridge 71 and disposed at an open end of the interior casing 61; a rotary drive tube 55 anchored on the bottom of the interior casing 61 and having internal threads 59; a hollow, cylindrical support frame 54 disposed on the rotary drive tube 55 and extending out of the rim 58; externally threaded shank 60 driven through the support frame 54 to secure to the internal threads 59 in the rotary drive tube 55; a rotary carrier 53 integrally formed with the externally threaded shank 60 and disposed in the support frame 54; and a lip stick 57 fastened by the rotary carrier 53.

The cap 50 includes a resilient layer 52 on both an inner surface and a blind end, and an annular second ridge 70 adjacent to its open end. Then annular second ridge 70 is complimentarily engaged with the annular first ridge 71 and the resilient layer 52 urges against the rim 58 when the cap 50 and the casing assembly 51 are secured together. The flange 56 is clamped by the cap 50 and the casing assembly 51. It is noted that the resilient layer 52 is elastically deformed to urge against the rim 58 so that no fluid flow is allowed to pass through the joining portion of the resilient layer 52 and the rim 58.

While the invention has been described in terms of preferred embodiments, those skilled in the art will recognize that the invention can be practiced with modifications within the spirit and scope of the appended claims.

What is claimed is:

1. A process of manufacturing a cap of a cosmetic container comprising the steps of:
heating and melting polymers, feeding the molten polymers into a first mold, cooling and hardening the molten polymers to a configuration of the first mold to form a cap, and ejecting the cap from the first mold;
feeding the cap into a second mold, and heating a polymeric material to a predetermined temperature until the polymeric material is molten wherein the predetermined temperature is sufficient to melt an inner surface of the cap;
injecting the molten polymeric material into the cap to coat the inner surface of the cap, cooling and hardening the cap, and ejecting the cap from the second mold wherein the polymeric material is adhered to the inner surface of the cap; and
forming a resilient layer on the inner surface of the cap by the polymeric material, and releasably securing a casing assembly to an open end of the cap.

2. The process of claim 1, wherein the casing assembly includes an interior casing, an annular flange at an intermediate portion of the interior casing, and an annular first ridge forwardly of the annular flange; a rotary drive tube anchored on a bottom of the interior casing; a support frame disposed on the rotary drive tube and extending out of the interior casing; externally threaded shank secured to the rotary drive tube; and a rotary carrier secured to the externally threaded shank and disposed in the support frame.

3. The process of claim 1, wherein the cap includes an annular second ridge adjacent to an open end thereof.

4. The process of claim 1, wherein the cap is formed of thermosetting polymer.

5. The process of claim 2, wherein the interior casing further comprises a rim disposed at an open end thereof.

6. The process of claim 2, wherein the rotary drive tube includes internal threads.

7. The process of claim 2, wherein the support frame is a hollow cylinder.

8. The process of claim 2, further comprising a lip stick fastened by the rotary carrier.
